(19) United States
(12) Patent Application Publication
(10) Pub. No.: US 2021/0054722 A1
(43) Pub. Date: Feb. 25, 2021

(54) DEVICE FOR TREATING A BOTTOM-HOLE FORMATION WELLBORE

(71) Applicant: LAMROCK CANADA INCORPORATED, Calgary (CA)

(72) Inventors: Jordan BRENNAN, CALGARY (CA); Edward BRENNAN, CALGARY (CA)

(21) Appl. No.: 17/089,571

(22) Filed: Nov. 4, 2020

Related U.S. Application Data
(63) Continuation of application No. PCT/CA2019/050598, filed on May 3, 2019.
(60) Provisional application No. 62/667,410, filed on May 4, 2018.

(51) Int. Cl. E21B 37/06; C09K 8/72; E21B 43/116

(52) U.S. Cl. CPC E21B 37/06; E21B 43/116; C09K 8/725

(57) ABSTRACT

A device for treating a bottom-hole formation of a wellbore comprises a firing head and seal block assembly at a proximal end thereof and a bullnose assembly at a distal end thereof. A carrier tube extends between the firing head and the bullnose assembly. A perforating gun extends between the carrier tube and the bullnose assembly. The carrier tube contains a combustible chemical composition which generates hydrochloric acid gas or hydrofluoric acid gas or a combination thereof when combusted. There is a charge wire electrically connecting the firing head and sealing block assembly to the combustible chemical composition.

### BACKGROUND OF THE INVENTION

### Field of the Invention

The present invention relates to a device for treating a wellbore and, in particular, to a device which generates hydrochloric acid gas, hydrofluoric acid gas or a combination thereof to treat a bottom-hole of a wellbore.

### Description of the Related Art

It is known that a decrease in the permeability of a bottom-hole formation of a wellbore may result in a decrease in hydrocarbon recovery. The decrease in the permeability of the bottom-hole formation may be the result of dilatation due to asphaltic deposits or volumetric readjustments of bore space structure. Alternatively, the decrease in the permeability of the bottom-hole formation may be the result of clogging from clay swelling or deposits of foreign matter such as mechanical impurities, filtrates, well knitting, drill-in fluids, well development fluids, and cement. Sand and paraffin-hydrate plugs are also known to cause a decrease in the permeability of the bottom-hole formation as are calcium carbonate scale, calcium sulfate scale, and other scale. It is therefore desirable to treat the bottom-hole formation of a wellbore to increase the permeability of a bottom-hole formation and increase hydrocarbon recovery.

### SUMMARY OF THE INVENTION

It is an object of the present invention to provide an improved device for treating a bottom-hole formation of a wellbore.

There is accordingly provided a device for treating a wellbore. The device comprises a firing head and seal block assembly at a proximal end thereof and a bullnose assembly at a distal end thereof. A carrier tube extends between the firing head and seal block assembly and the bullnose assembly. A perforating gun extends between the carrier tube and the bullnose assembly. The carrier tube contains a combustible chemical composition which generates hydrochloric acid gas or hydrofluoric acid gas or a combination thereof when combusted. There is a charge wire electrically connecting the firing head and sealing block assembly to the combustible chemical composition. There may be a blow-out plug cross-over assembly between the carrier tube and the perforating gun. The carrier tube may have a plurality of lateral openings. There may be a spacer tube extending between the firing head and seal block assembly and the carrier tube. A mandrel may couple the spacer tube to the carrier tube. There may be a perforating gun coupled to the carrier tube.

The combustible chemical composition may comprise between 30% and 60% by weight hexachloroethane and between 40% and 70% by weight ammonium nitrate. The combustible chemical composition may alternatively comprise between 30% and 60% by weight polyvinyl chloride and between 40% and 70% by weight ammonium nitrate. The combustible chemical composition may still alternatively comprise between 0% and 5% by weight polyvinyl chloride, between 25% and 55% by weight hexachloroethane, and between 40% and 70% by weight ammonium nitrate. The combustible chemical composition may still yet alternatively comprise between 5% and 25% by weight polytetrafluoroethylene, between 25% and 55% by weight hexachloroethane, and between 40% and 70% by weight ammonium nitrate.

The combustible chemical composition may be disposed in a sleeve. The sleeve may be a polyvinyl chloride sleeve. The combustible chemical composition may include a plurality of solid puck shaped members. The combustible chemical composition may further include an adhesive binding adjacent ones of the solid puck shaped members. The combustible chemical composition may further include a combustion catalyst.

### BRIEF DESCRIPTIONS OF DRAWINGS

The invention will be more readily understood from the following description of the embodiments thereof given, by way of example only, with reference to the accompanying drawings, in which:

FIG. 1 is an elevation, partially sectional, view showing a device for treating a bottom-hole formation of a vertical wellbore;

FIG. 2 is an exploded, perspective view of the device for treating a bottom-hole formation of a wellbore shown in FIG. 1;

FIG. 3 is an elevation, fragmentary and partially sectional, view of the device for treating a bottom-hole formation of a wellbore shown in FIG. 1;

FIG. 4 is a perspective view of a first carrier tube of the device for treating a bottom-hole formation of a wellbore shown in FIG. 1;

FIG. 5 is a perspective view of a second carrier tube of the device for treating a bottom-hole formation of a wellbore shown in FIG. 1;

FIG. 6 is a schematic, exploded view showing a connection between a sleeve of a combustible chemical composition of the first carrier tube and a sleeve of a combustible chemical composition of the second carrier tube of the device for treating a bottom-hole formation of a wellbore of FIG. 1;

FIG. 7 is an elevation view of the sleeve of the combustible chemical composition of the first carrier tube of the device for treating a bottom-hole formation of a wellbore shown in FIG. 1; and

FIG. 8 is an elevation view of the sleeve of the combustible chemical composition of the second carrier tube of the device for treating a bottom-hole formation of a wellbore shown in FIG. 1.

FIG. 9 is an elevation, partially sectional, view showing a device for treating a bottom-hole formation of a vertical wellbore;

FIG. 10 is another elevation, partially sectional, view showing the for treating a bottom-hole formation of a vertical wellbore shown in FIG. 9;

FIG. 11 is a perspective view of the device for treating a bottom-hole formation of a wellbore shown in FIG. 9;

FIG. 12 is a perspective view of the device for treating a bottom-hole formation of a wellbore shown in FIG. 9 coupled to another such device;

FIG. 13 is an elevation, partially sectional, view showing a device for treating a bottom-hole formation of a vertical wellbore;

FIG. 14 is another elevation, partially sectional, view showing the for treating a bottom-hole formation of a vertical wellbore shown in FIG. 13;

FIG. 15 is a perspective view of the device for treating a bottom-hole formation of a wellbore shown in FIG. 13; and

FIG. 16 is a perspective view of the device for treating a bottom-hole formation of a wellbore shown in FIG. 13 coupled to another such device.

### DESCRIPTIONS OF THE PREFERRED EMBODIMENTS

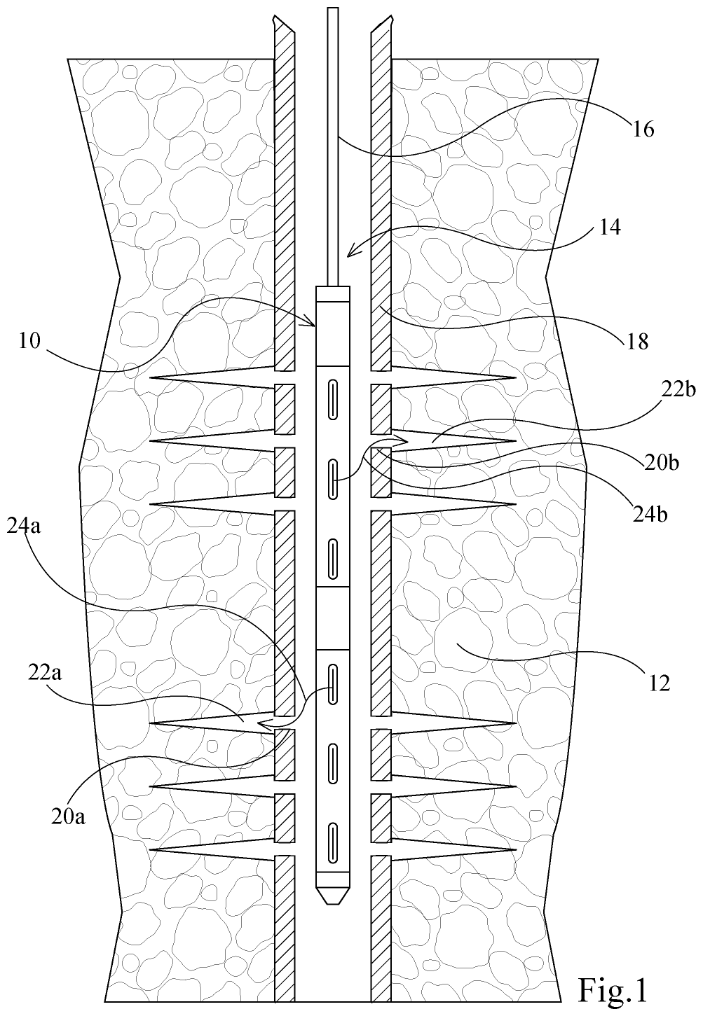

Referring to the drawings and first to FIG. 1, there is shown a device 10 for treating a bottom-hole formation 12 of a wellbore 14. The device 10 is lowered into the wellbore 14 by a wireline 16 in this example. However, in other examples, coiled tubing or other suitable means may be employed to lower the device 10 into the wellbore 14. The wellbore 14 is cased with a perforated casing 18. Gas generated by the device 10 to treat the bottom-hole formation 12 of the wellbore 14 flows through perforations in the perforated casing 18, for example perforations 20a and 20b of the perforated casing 18, into corresponding perforations in the bottom-hole formation 12, for example perforations 22a and 22b of the bottom-hole formation 12, as indicated generally by arrows 24a and 24b. It will be understood by a person skilled in the art that the device 10 may also be employed to treat a wellbore provided with a slotted liner or an open hole wellbore. It will also be understood by a person skilled in the art that the device 10 may be deployed in a vertical wellbore or horizontal wellbore. It will further be understood by a person skilled in the art that the device may be deployed in a producing wellbore or an injection wellbore.

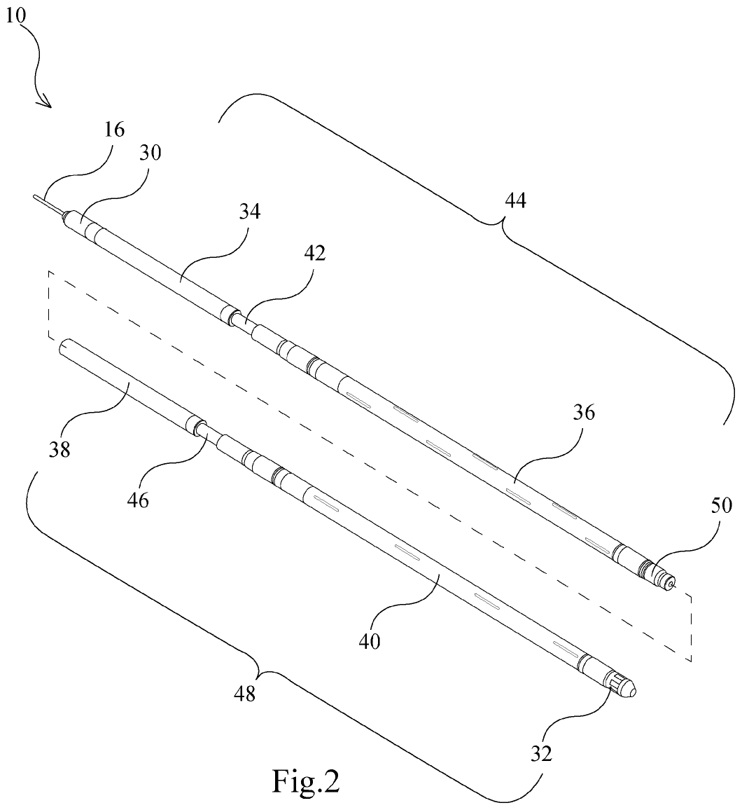

The device 10 is shown in greater detail in FIG. 2. The device 10 comprises a firing head and sealing block assembly 30 at a proximal end thereof and a bullnose assembly 32 at a distal end thereof. A proximal end of a first spacer tube 34 is coupled to the firing head and sealing block assembly 30. A first carrier tube 36 is coupled to a distal end of the first spacer tube 34. A second spacer tube 38 is coupled to a distal end of the first carrier tube 36. A second carrier tube 40 is coupled to a distal end of the second spacer tube 38. A distal end of the second carrier tube 40 is coupled to the bullnose assembly 32. The first spacer tube 34 and the first carrier tube 36 are coupled by a mandrel 42 and together form a first assembly 44 of the device 10 for treating the bottom-hole formation of the wellbore. The second spacer tube 38 and the second carrier tube 40 are also coupled by a mandrel 46 and together form a second assembly 48 of the device 10 for treating the bottom-hole formation of the wellbore. A hang off sub 50 couples the first assembly 44 of the device 10 for treating the bottom-hole formation of the wellbore to the second assembly 48 of the device 10 for treating the bottom-hole formation of the wellbore.

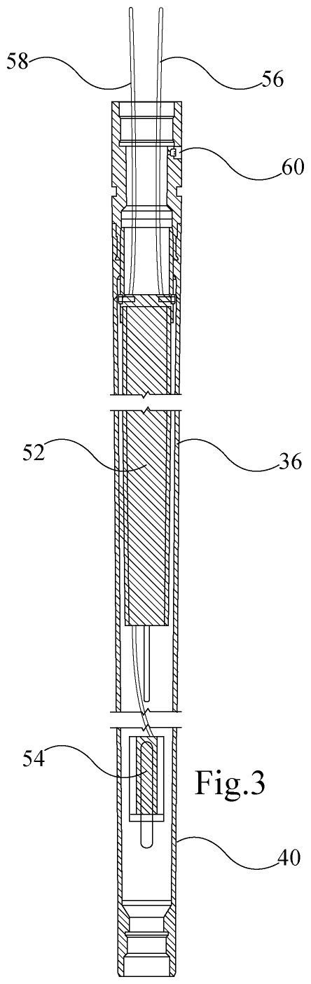

The first carrier tube 36 and the second carrier tube 40 each contain a combustible chemical composition which generates hydrochloric acid gas or hydrofluoric acid gas or a combination thereof when combusted. FIG. 3 shows a combustible chemical composition 52 contained in the first carrier tube 36 and a combustible chemical composition 54 contained in the second carrier tube 40. In this example, the combustible chemical composition 52 is contained in the first carrier tube 36 and comprises a plurality of puck shaped members, for example puck shaped member 52a and 52b, which are fitted into a sleeve 53. The sleeve 53 may be formed of polyvinyl chloride and there may be epoxy lining an inner surface of the sleeve 53. In this example, the combustible chemical composition 54 is contained in the second carrier tube 40 and comprises a plurality of puck shaped members, for example puck shaped member 54a and 54b, which are fitted into a sleeve 55. The sleeve 55 may be formed of polyvinyl chloride and there may be epoxy lining an inner surface of the sleeve 55. The combustible chemical compositions 52 and 54 will combust through the respective sleeves 53 and 55.

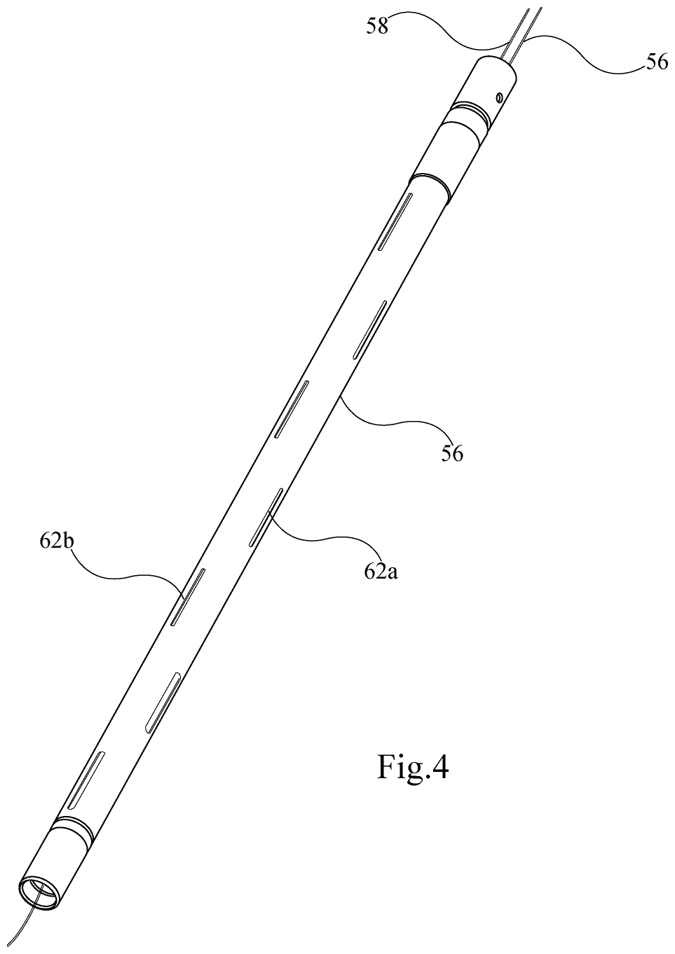

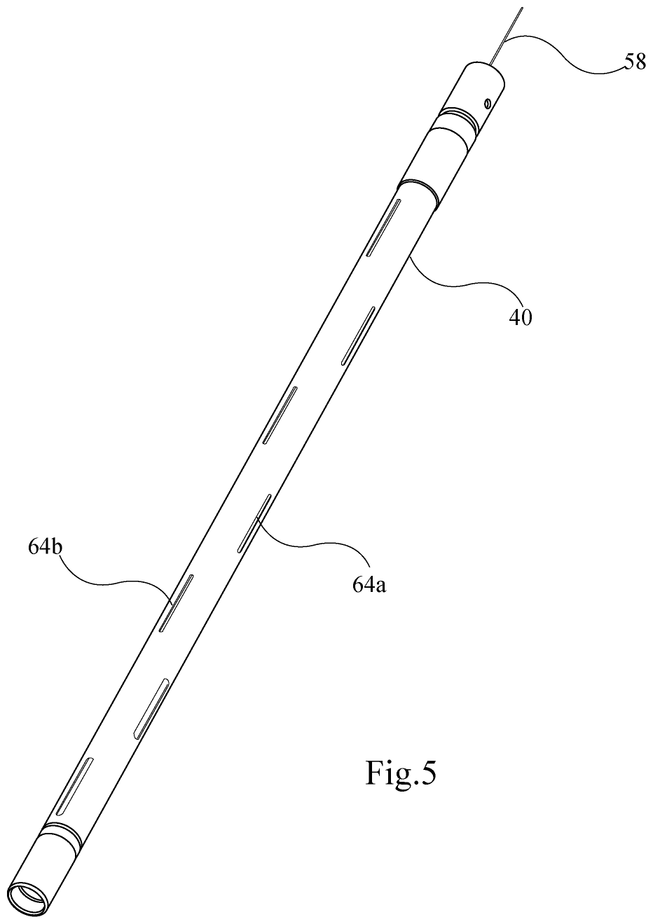

A charge wire 56 provides a charge to combust the combustible chemical composition 52 contained in the first carrier tube 36. A flow through charge wire 58 provides a charge to combust the combustible chemical composition 54 contained in the second carrier tube 40. In this example, at least one of the puck shaped members is a combustion catalyst comprising epoxy resin, potassium dichromate, and ammonium nitrate. However, it will be understood by a person skilled in the art that a combustion catalyst is not required but any suitable combustion catalyst may be employed. The first carrier tube 36 and the second carrier tube 40 are each respectively shown in FIGS. 4 and 5. The first carrier tube 36 has a plurality of lateral openings, for example, slots 62a and 62b. The second carrier tube 40 has a plurality of lateral openings, for example, slots 64a and 64b. The hydrochloric acid gas or hydrofluoric acid gas or a combination thereof, generated when the combustible chemical composition 52 contained in the first carrier tube 36 and the combustible chemical composition 54 contained in the second carrier tube 40 are combusted, flows through the slots 62a and 62b in the first carrier tube 36 and the slots 64a and 64b in the second carrier tube 40.

The combustible chemical compositions contained in the first carrier tube 36 and the second carrier tube 40 may be the same or may be different. Examples of the combustible chemical compositions are set out below. Examples 1-3 and 5-7 generate hydrochloric acid gas and examples 4 and 8 generate hydrochloric acid gas and hydrofluoric acid gas.

### Example 1

| Component | Percent by Weight |
|---|---|
| Hexachloroethane | 30% to 60% |
| Ammonium nitrate | 40% to 70% |

### Example 2

| Component | Percent by Weight |
|---|---|
| Chlorinated polyvinyl chloride | 30% to 60% |
| Ammonium nitrate | 40% to 70% |

### Example 3

| Component | Percent by Weight |
|---|---|
| Chlorinated polyvinyl chloride | 0% to 5% |
| Hexachloroethane | 25% to 55% |
| Ammonium nitrate | 40% to 70% |

### Example 4

| Component | Percent by Weight |
|---|---|
| Polytetrafluoroethylene | 5% to 25% |
| Hexachloroethane | 25% to 55% |
| Ammonium nitrate | 40% to 70% |

### Example 5

| Component | Percent by Weight |
|---|---|
| Hexachloroethane | 30% to 60% |
| Ammonium nitrate | 40% to 70% |
| Potassium Dichromate | 2% and 12%. |

### Example 6

| Component | Percent by Weight |
|---|---|
| Chlorinated polyvinyl chloride | 30% to 60% |
| Ammonium nitrate | 40% to 70% |
| Potassium Dichromate | 2% and 12%. |

### Example 7

| Component | Percent by Weight |
|---|---|
| Chlorinated polyvinyl chloride | 0% to 5% |
| Hexachloroethane | 25% to 55% |
| Ammonium nitrate | 40% to 70% |
| Potassium Dichromate | 2% and 12%. |

### Example 8

| Component | Percent by Weight |
|---|---|
| Polytetrafluoroethylene | 5% to 25% |
| Hexachloroethane | 25% to 55% |
| Ammonium nitrate | 40% to 70% |
| Potassium Dichromate | 2% and 12%. |

In the above examples, a chlorinated polyvinyl chloride is employed. However, in other examples, any suitable polyvinyl chloride may be employed.

A self-levelling, chemical resistant, high performance sealant may be employed to seal each end of the device 10. In this example, the sealant is a two-part polysulfide sealant offered under the trademark Thiokol®. However, it will be understood by a person skilled in the art that silicone based sealants or other suitable sealants may be employed as an alternative to the Thiokol® sealant. It will also be understood by a person skilled in the art that the device may be sealed mechanically or by other suitable means.

An adhesive may be employed to bind the puck shaped members. The adhesive may be a cured epoxy resin system which is a mixture of an epoxy resin, a hardener and a plasticizer. The epoxy resin employed may include a typical bispenol A type resin. An example of an adhesive is set out below. However, it will be understood by a person skilled in the art that other suitable adhesives or binding agents may be employed.

| Component | Percent by Weight |
|---|---|
| Epoxy resin (DER-331 ®) | about 80% |
| Plasticizer | about 10% |
| Hardener (Aradur 42BD ®) | about 10% |

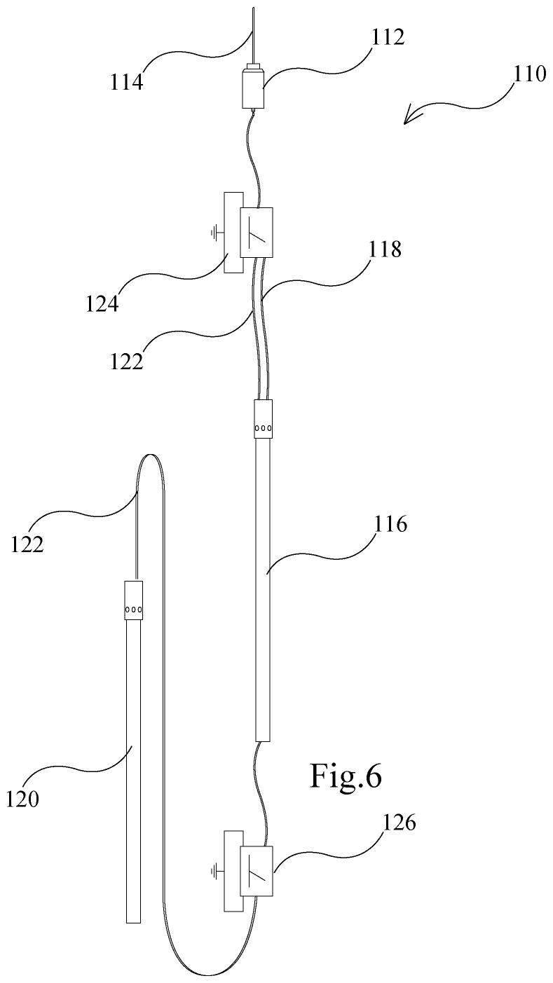

Referring now to FIG. 6, there is shown a connection between the sleeve 53 of the combustible chemical composition of the first carrier tube 36 (not shown in FIG. 6) and the sleeve 55 of the combustible chemical composition the second carrier tube 40 (not shown in FIG. 6). A firing head 66 is tethered to the wireline 16. The firing head 66 is electrically connected to the sleeve 53 of the combustible chemical composition of the first carrier tube 36 by the charge wire 56. The firing head 66 is also electrically connected to the sleeve 55 of the combustible chemical composition of the second carrier tube 40 by the flow through charge wire 58. There is a first switch 72 connected in series between the firing head 66 and the sleeve 53 of the combustible chemical composition of the first carrier tube 36. There is a second switch 74 connected in series between the firing head 66 and the sleeve 55 of the combustible chemical composition of the second carrier tube 40. The first switch 72 and the second switch 74 allow for selective combustion of the combustible chemical composition of the first carrier tube 36 and the combustible chemical composition of the second carrier tube 40.

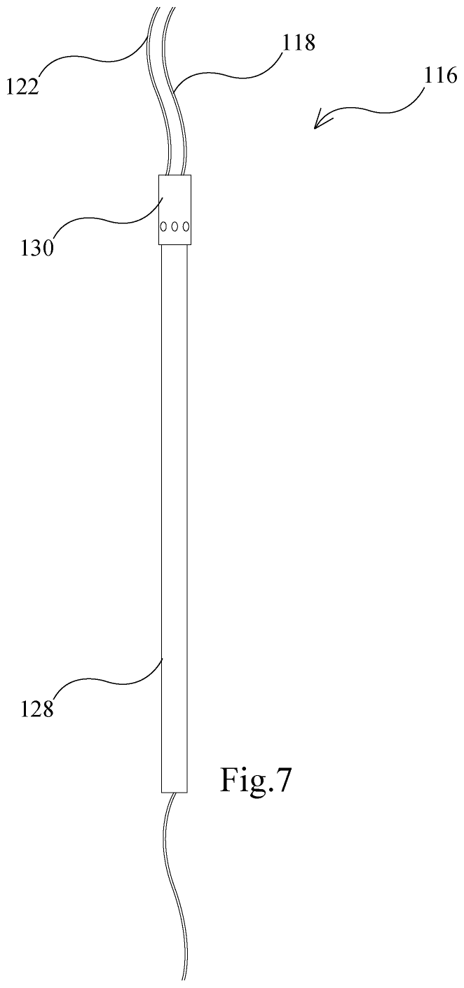

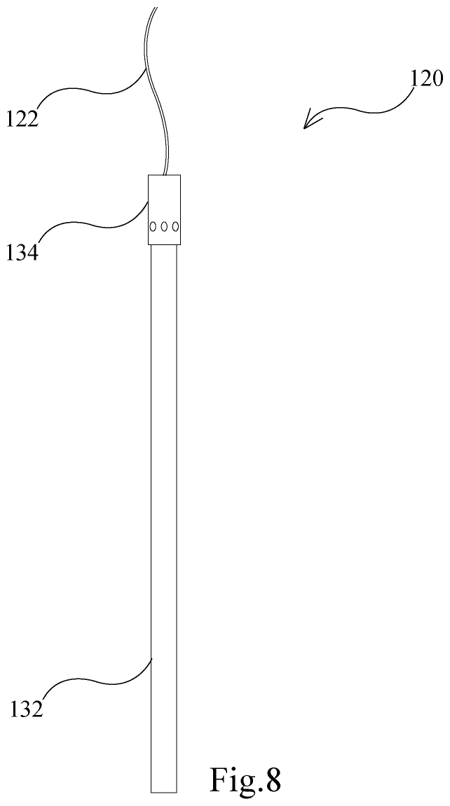

The sleeve 53 of the combustible chemical composition of the first carrier tube 36 and the sleeve 55 of the combustible chemical composition of the second carrier tube 40 are each respectively shown in greater detail in FIGS. 7 and 8. The sleeve 53 of the combustible chemical composition of the first carrier tube 36 (not shown in FIG. 7) generally comprises a tube portion 76 which contains the combustible material and a sealing cap 78. The tube portion 76 is combustible and may combust, or partially combust, with the combustible chemical composition to generate hydrochloric acid gas or hydrofluoric acid gas or a combination thereof. The sleeve 55 of the combustible chemical composition of the second carrier tube 40 (not shown in FIG. 6) generally comprises a tube portion 80 which contains the combustible material and a sealing cap 82. The tube portion 80 is combustible and may combust, or partially combust, with the combustible chemical composition to generate hydrochloric acid gas or hydrofluoric acid gas or a combination thereof.

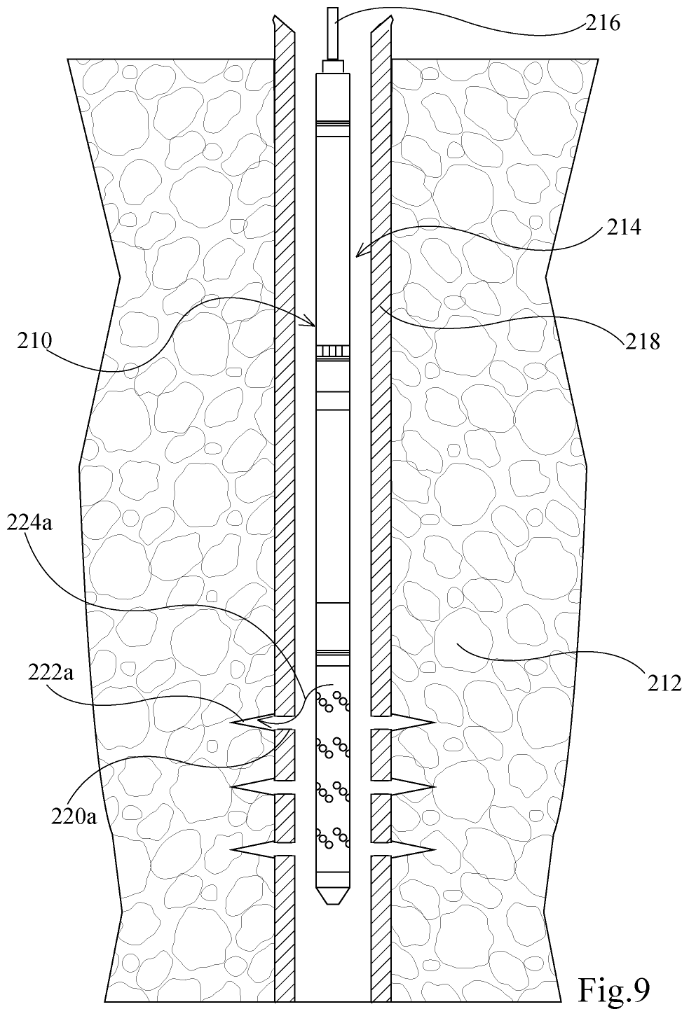

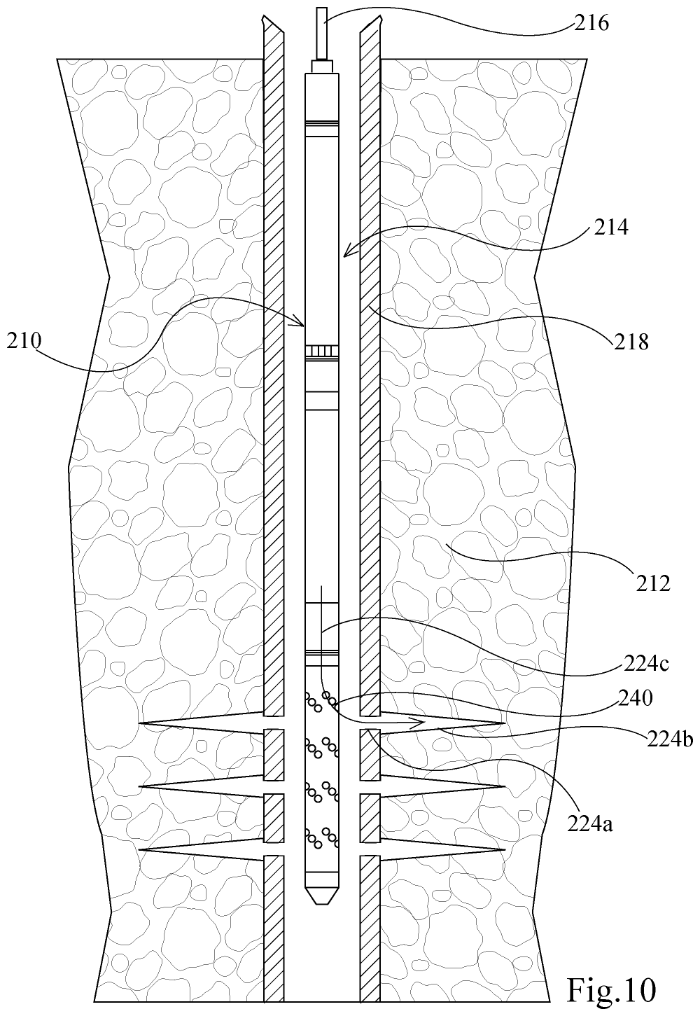

FIGS. 9 and 10 show another device 210 for treating a bottom-hole formation 212 of a wellbore 214. The device 210 is lowered into the wellbore 214 by a wireline 216 in this example. However, in other examples, coiled tubing or other suitable means may be employed to lower the device 210 into the wellbore 214. The wellbore 214 is cased with a casing 218 in this example. The device 210 is employed to perforate the casing 218 and treat the bottom-hole formation 212. FIG. 9 shows a perforation 220a in the casing 218, and a corresponding perforation 222a in the bottom-hole formation 212, being formed as indicated generally by arrow 224a. FIG. 10 shows gas, generated by the device 210 to treat the bottom-hole formation 212 of the wellbore 214, flow through a perforation 224a in the casing 218 and into a corresponding perforation 224b in the bottom-hole formation 212, as indicated generally by arrow 224c. It will be understood by a person skilled in the art that the device 210 may also be employed to treat a wellbore provided with a slotted liner or an open hole wellbore. It will also be understood by a person skilled in the art that the device 210 may be deployed in a vertical wellbore or horizontal wellbore. It will further be understood by a person skilled in the art that the device may be deployed in a producing wellbore or an injection wellbore.

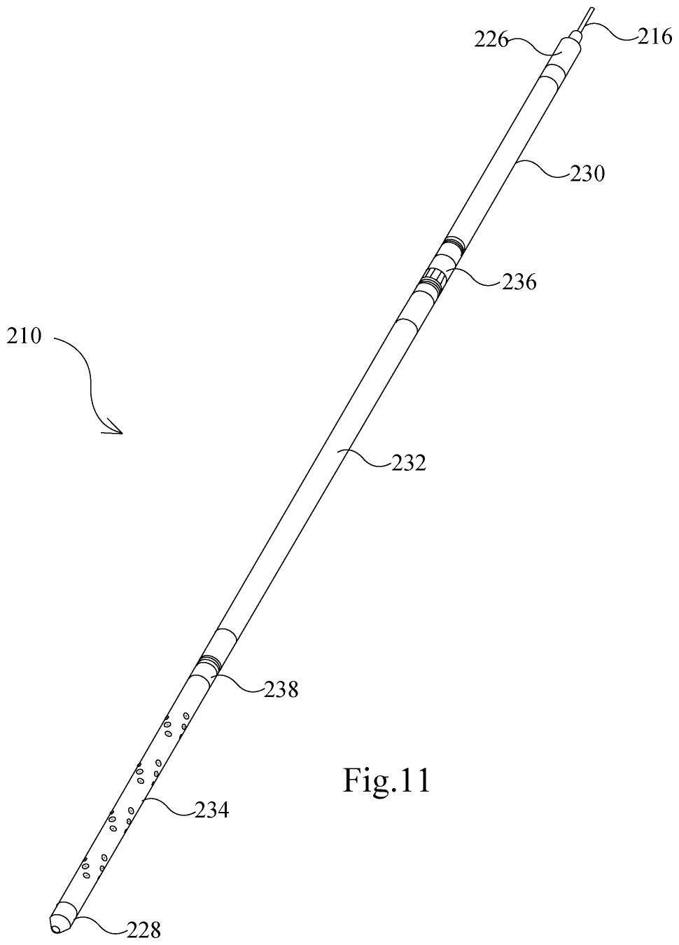

The device 210 is shown in greater detail in FIG. 11. The device 210 comprises a firing head and sealing block assembly 226 which is tethered to the wireline 216 at a proximal end thereof and a bullnose assembly 228 at a distal end thereof. A proximal end of a spacer tube 230 is coupled to the firing head and sealing block assembly 226. A proximal end of a carrier tube 232 is coupled to a distal end of the spacer tube 230 and a perforating gun 234 is coupled to a distal end of the carrier tube 232. The spacer tube 230 and the carrier tube 232 are coupled by a mandrel 236. The carrier tube 232 and the perforating gun 234 are coupled by a blow out plug cross-over assembly 238. The carrier tube 232 contains a combustible chemical composition (not shown in FIG. 11) which generates hydrochloric acid gas or hydrofluoric acid gas or a combination thereof when combusted. The combustible chemical composition is similar to the combustible chemical composition 52 described earlier herein and may likewise comprises a plurality of puck shaped members in a sleeve.

The perforating gun 234 is first fired to perforate the casing 218 and the bottom-hole formation 212 as shown in FIG. 9. The blow out plug cross-over assembly 238 protects the combustible chemical composition in the carrier tube 232 when the perforating gun 234 is fired. The combustible chemical composition in the carrier tube 232 is then combusted in a manner similar to as disclosed for the combustible chemical composition in the device shown in FIGS. 1 to 8. The hydrochloric acid gas or hydrofluoric acid gas or a combination thereof generated from the combustion of the combustible chemical composition results in an increase in pressure in the carrier tube 232. The increase in pressure results in the blow out plug cross-over assembly 238 being blown out and the carrier tube 232 being in fluid communication with the perforating gun 234. The hydrochloric acid gas or hydrofluoric acid gas or a combination thereof then flows through openings, for example, opening 240, in the perforating gun 234 as shown in FIG. 10. In this example, the perforating gun 234 is fired and the combustible chemical composition is combustion in sequence. However, in other example, the perforating gun 234 is fired and the combustible chemical composition is combustion simultaneously.

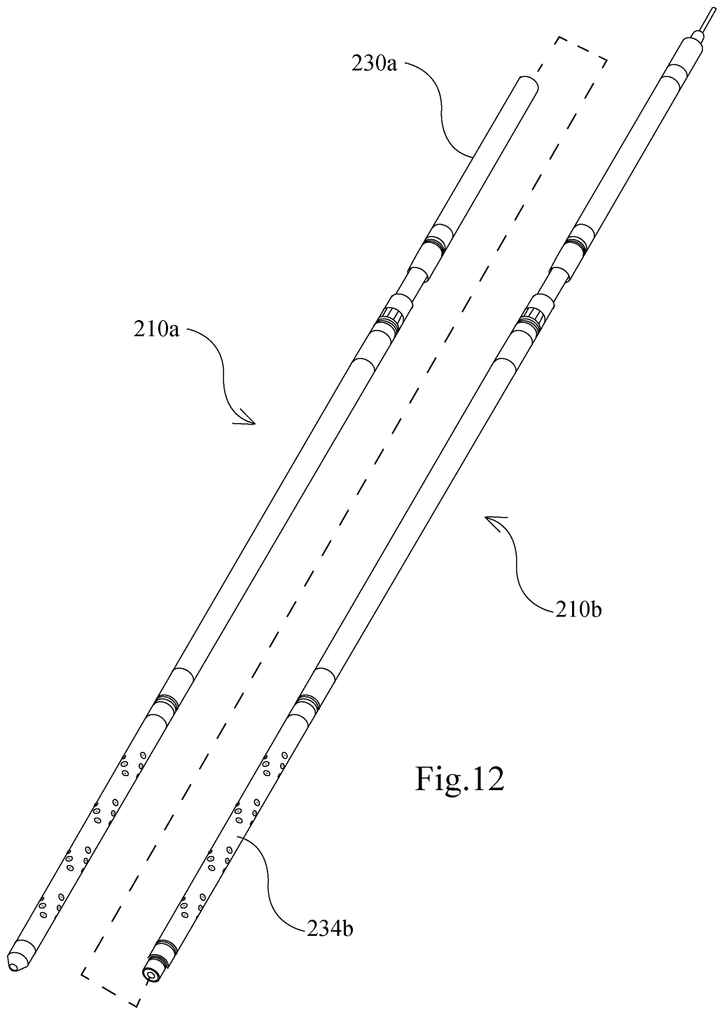

The device 210 may also be deployed in series, as shown in FIG. 12, in which a spacer tube 230a of a first device 210a is coupled to a perforating gun 234b of a second device 210b. The series may include any suitable number of devices having any suitable dimensions. The perforating guns and the combustible chemical compositions of the devices are electrically connected by charge wires and flow through charge wires, similar to the type shown in FIG. 6, which are insulated. There may also be switches, similar to the type shown in FIG. 6, between the first device 210a and the second device 210b to allow for selective firing of the perforating guns and combustion of the combustible chemical compositions of the devices. Packers may also be employed to isolate the devices.

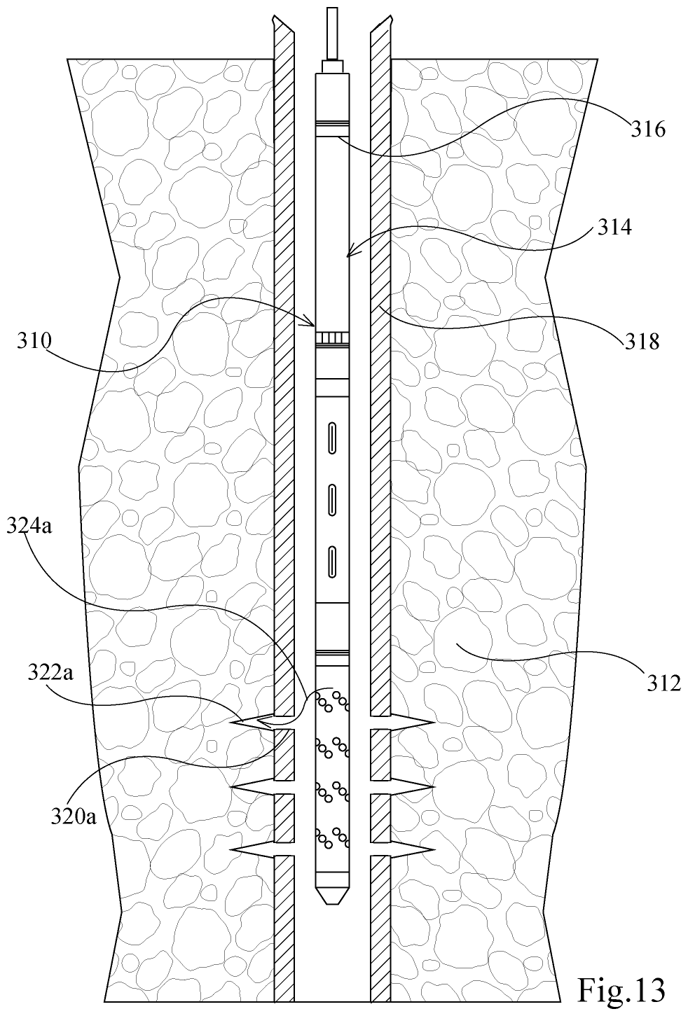

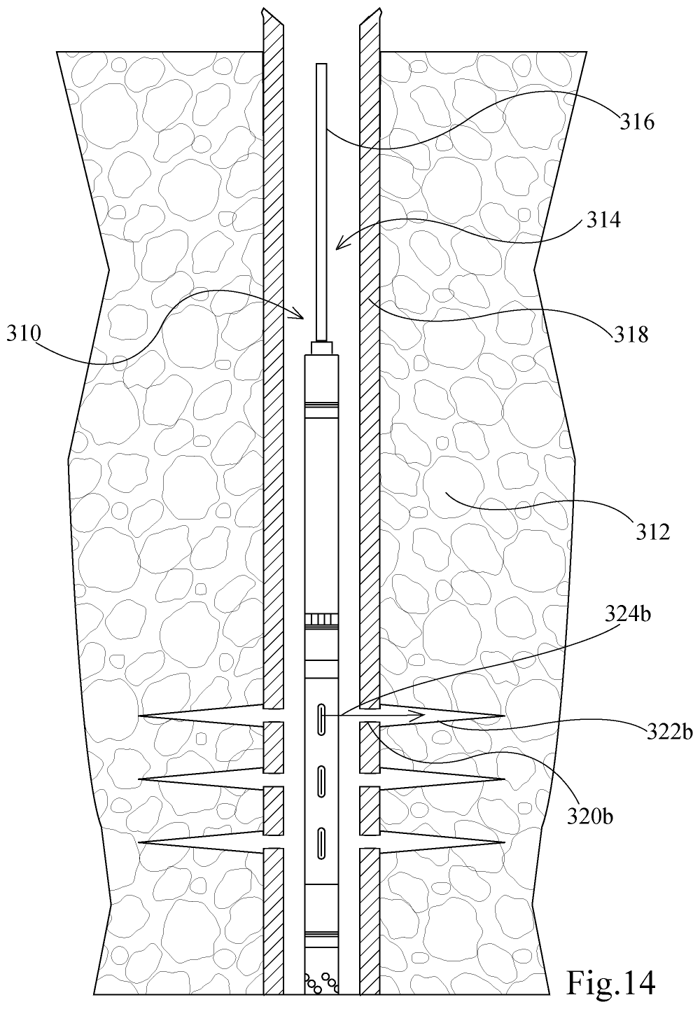

FIGS. 13 and 14 show another device 310 for treating a bottom-hole formation 312 of a wellbore 314. The device 310 is lowered into the wellbore 314 by a wireline 316 in this example. However, in other examples, coiled tubing or other suitable means may be employed to lower the device 310 into the wellbore 314. The wellbore 314 is cased with a casing 318 in this example. The device 310 is employed to perforate the casing 318 and treat the bottom-hole formation 312. FIG. 13 shows a perforation 320a in the casing 318, and a corresponding perforation 322a in the bottom-hole formation 312, being formed as indicated generally by arrow 324a. FIG. 14 shows gas, generated by the device 310 to treat the bottom-hole formation 312 of the wellbore 314, flow through a perforation 320b in the casing 318 and into a corresponding perforation 322b in the bottom-hole formation 312, as indicated generally by arrow 324b. It will be understood by a person skilled in the art that the device 310 may also be employed to treat a wellbore provided with a slotted liner or an open hole wellbore. It will also be understood by a person skilled in the art that the device 310 may be deployed in a vertical wellbore or horizontal wellbore. It will further be understood by a person skilled in the art that the device may be deployed in a producing wellbore or an injection wellbore.

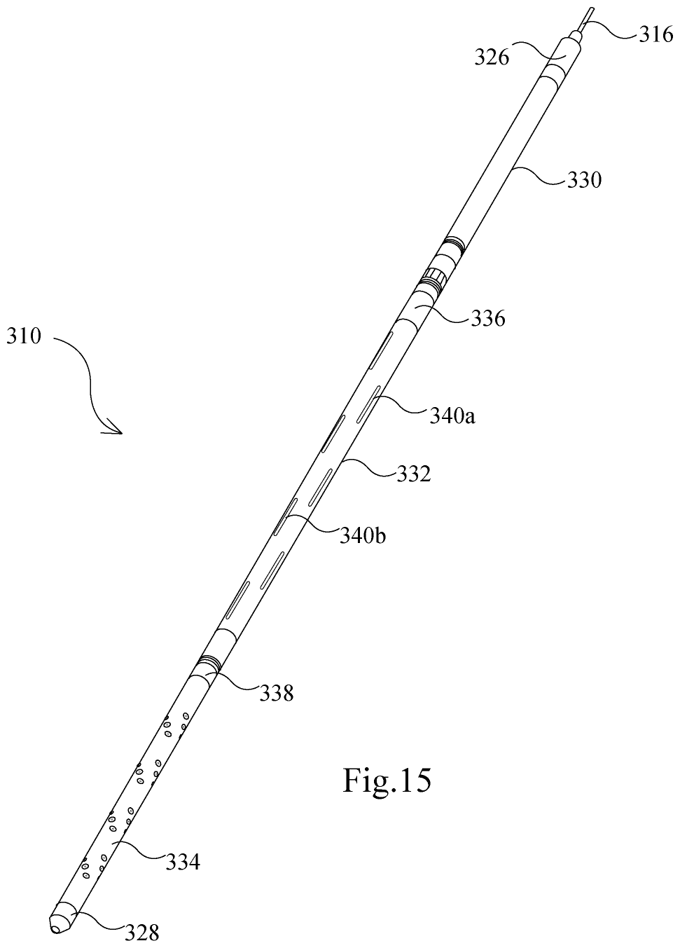

The device 310 is shown in greater detail in FIG. 15. The device 310 comprises a firing head and sealing block assembly 326 which is tethered to the wireline 316 at a proximal end thereof and a bullnose assembly 328 at a distal end thereof. A proximal end of a spacer tube 330 is coupled to the firing head and sealing block assembly 326. A proximal end of a carrier tube 332 is coupled to a distal end of the spacer tube 330 and a perforating gun 334 is coupled to a distal end of the carrier tube 332. The spacer tube 330 and the carrier tube 332 are coupled by a mandrel 336 and the carrier tube 332 and the perforating gun 334 are coupled by a blow out plug cross-over assembly 338. The carrier tube 332 contains a combustible chemical composition (not shown in FIG. 15) which generates hydrochloric acid gas or hydrofluoric acid gas or a combination thereof when combusted. The combustible chemical composition is similar to the combustible chemical composition 52 described earlier herein and may likewise comprises a plurality of puck shaped members in a sleeve.

The perforating gun 334 is first fired to perforate the casing 318 and the bottom-hole formation 312 as shown in FIG. 13. The blow out plug cross-over assembly 238 protects the combustible chemical composition in the carrier tube 232 when the perforating gun 234 is fired. The device 310 is then moved downhole, as shown in FIG. 14, so that the carrier tube 332 is aligned with, for example, the perforation 320b in the casing 318 and the corresponding perforation 322b in the bottom-hole formation 312. The combustible chemical composition is then combusted in a manner similar to as disclosed for the combustible chemical composition in the device shown in FIGS. 1 to 8. The hydrochloric acid gas or hydrofluoric acid gas or a combination thereof generated from the combustion of the combustible chemical composition then flows through the openings, for example, openings 340a and 340b, in the carrier tube 332 as shown in FIG. 15. The blow out plug cross-over assembly 238 is not blown out because there is no increase in pressure in the carrier tube 232 as the hydrochloric acid gas or hydrofluoric acid gas or a combination thereof is vented through the openings 340a and 340b, in the carrier tube 332 as described above.

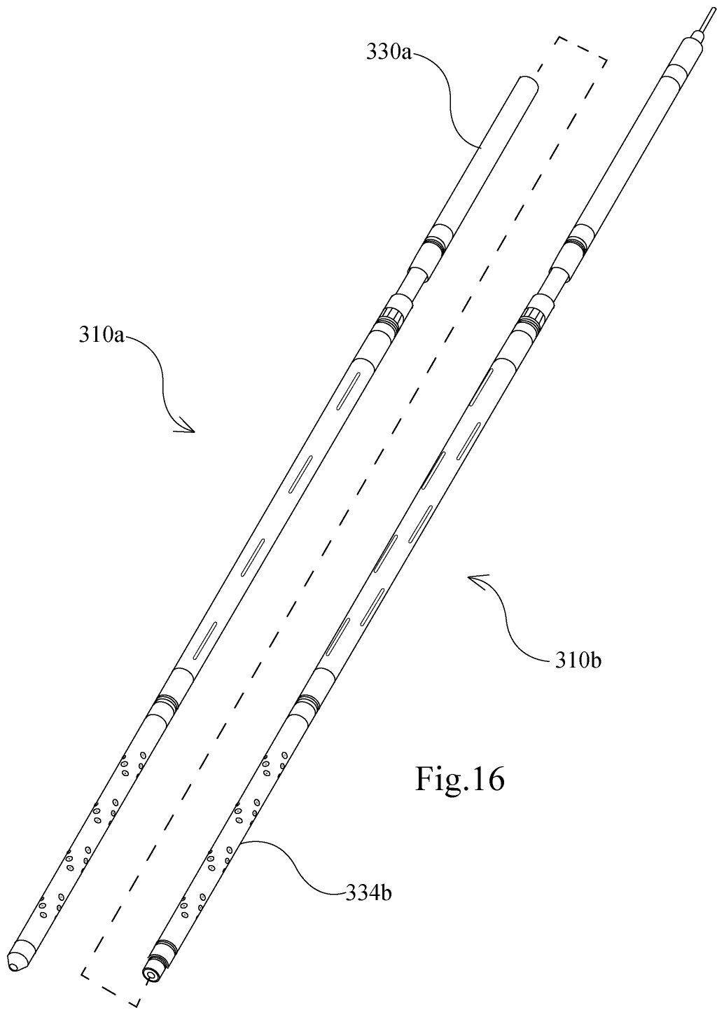

The device 310 may also be deployed in series, as shown in FIG. 16, in which a spacer tube 330a of a first device 310a is coupled to a perforating gun 334b of a second device 310b. The series may include any suitable number of devices having any suitable dimensions. The perforating guns and the combustible chemical compositions of the devices are electrically connected by charge wires and flow through charge wires, similar to the type shown in FIG. 6, which are insulated. There may also be switches, similar to the type shown in FIG. 6, between the first device 210a and the second device 210b to allow selective firing of the perforating guns and selective combustion of the combustible chemical composition of the devices. Packers may also be employed to isolate the devices.

It will also be understood by a person skilled in the art that many of the details provided above are by way of example only, and are not intended to limit the scope of the invention which is to be determined with reference to the following claims.

What is claimed is:

1. A device for treating a bottom-hole formation of a wellbore, the device comprising:
a firing head and seal block assembly at a proximal end thereof;
a bullnose assembly at a distal end thereof;
a carrier tube extending from the firing head and seal block assembly the carrier tube containing a combustible chemical composition which generates hydrochloric acid gas or hydrofluoric acid gas or a combination thereof when combusted;
a perforating gun extending between the carrier tube and the bullnose assembly; and
a charge wire electrically coupling the firing head and sealing block assembly to the combustible chemical composition.

2. The device as claimed in claim 1 further including a blow-out plug cross-over assembly between the carrier tube and the perforating gun.

3. The device as claimed in claim 1 wherein the carrier tube has a plurality of lateral openings.

4. The device as claimed in claim 1 further including a spacer tube extending between the firing head and seal block assembly and the carrier tube.

5. The device as claimed in claim 4 further including a mandrel coupling the spacer tube to the carrier tube.

6. The device according to claim 1, wherein the combustible chemical composition comprises between 30% and 60% by weight hexachloroethane and between 40% and 70% by weight ammonium nitrate.

7. The device according to claim 1, wherein the combustible chemical composition comprises between 30% and 60% by weight polyvinyl chloride and between 40% and 70% by weight ammonium nitrate.

8. The device according to claim 1, wherein the combustible chemical composition comprises between 0% and 5% by weight polyvinyl chloride, between 25% and 55% by weight hexachloroethane, and between 40% and 70% by weight ammonium nitrate.

9. The device according to claim 1, wherein the combustible chemical composition comprises between 5% and 25% by weight polytetrafluoroethylene, between 25% and 55% by weight hexachloroethane, and between 40% and 70% by weight ammonium nitrate.

10. The device according to claim 1, wherein the combustible chemical composition further comprises between 2% and 12% by weight potassium dichromate.

11. The device according to claim 1, wherein the combustible chemical composition is disposed in a sleeve.

12. The device according to claim 1, wherein the combustible chemical composition is disposed within a polyvinyl chloride sleeve.

13. The device according to claim 1, wherein the combustible chemical composition includes a plurality of puck shaped members.

14. The device according to claim 13, wherein the combustible chemical composition further includes an adhesive binding adjacent ones of the puck shaped members.

15. The device according to claim 13, wherein the combustible chemical composition further includes a combustion catalyst.
